(19) United States
(12) Patent Application Publication
(10) Pub. No.: US 2015/0086733 A1
(43) Pub. Date: Mar. 26, 2015

(54) PROCESS FOR THE MANUFACTURE OF A POLYPROPYLENE - PAPER LAMINATE AND A POLYPROPYLENE - PAPER LAMINATE

(71) Applicant: A Warne & Co. Ltd., London (GB)

(72) Inventors: Jonathan Robert Lewis Moore, London (GB); Andrew Richard Wakeley, London (GB)

(73) Assignee: A Warne & Co. Ltd., London (US)

(21) Appl. No.: 14/390,474

(22) PCT Filed: Apr. 5, 2013
(86) PCT No.: PCT/GB2013/050889

§ 371 Date: Oct. 3, 2014

(30) Foreign Application Priority Data
Apr. 5, 2012 (GB) 1206258.4

(51) Int. Cl. B32B 27/10; B32B 38/00; C09J 5/00; B32B 37/12; B32B 27/08; B32B 27/32

(52) U.S. Cl. CPC B32B 27/10; B32B 27/08; B32B 27/32; C09J 5/00; B32B 37/12; B32B 38/00; B32B 2250/02; B32B 2317/12; B32B 2323/10; B32B 2439/70; B32B 2255/24; B32B 2255/10
USPC 428/34.2; 428/523; 428/341; 156/60; 156/281

(57) ABSTRACT

The invention relates to a process for the manufacture of a polypropylene-paper laminate, comprising providing a film of biaxially-orientated polypropylene which does not carry any PVdC coating, and laminating said film to a paper substrate using a UV-curable adhesive; characterised in that said film is substantially free from fatty acid amides. The invention also relates to polypropylene-paper laminates and food packages containing the film. The invention also relates to a film of biaxially-orientated polypropylene substantially free from fatty acid amides, which carries an anti-mist coating on one of its faces.

The present invention relates to a process for the manufacture of a laminate comprising a polypropylene film bonded to a paper substrate, and to novel laminates and materials for making them.

It is known to use laminates comprising a film of thermoplastics material bonded to a paper substrate as packaging for food. The requirements for such packaging are challenging: the materials used must have suitable physical properties; they must be of low toxicity, and have as low an environmental impact as possible; they should not develop a haze on the inside of the packaging during storage; and the manufacturing methods should be as simple and economical as possible.

Typically, in order to make a package for food storage, for example a sandwich box of the type which is ubiquitous in supermarkets, the uncoated side of a film of thermoplastics material is bonded to a paper substrate; the resulting laminate is cut into the shape required for the package; and finally the blank is folded into a three-dimensional shape and the package closed and secured by heat sealing the appropriate overlapping sections together. The finished package is usually produced by means of modern, high-speed packaging machines of the type that form, fill and seal packages from a continuous web or from prefabricated blanks of the laminate.

Many films are prone to develop a haze, particularly when used for high-moisture content foods intended for display in chiller cabinets. To solve this problem, the thermoplastics film usually contains anti-mist additives.

There are a number of ways of bonding the thermoplastics film to the paper substrate. Various types of adhesive may be used. One particularly preferred method involves the use of a UV-curable adhesive. Such methods are well known in the art.

One preferred type of laminate currently on the market uses as the thermoplastic film a three-layer film in which the core layer comprises biaxially oriented polypropylene (BOPP), and the core is provided on each side with a layer or coating of polyvinylidene chloride (PVdC). The BOPP core contains anti-mist additives, slip additives and anti-blocking additives. The PVdC layers make the film heat-sealable, and also enable the film to be printed if desired. Such films are available commercially, for example from Innovia under the Trade Mark RK+. Such films can be bonded to paper using UV adhesives and heat-sealed. However, they have the disadvantage that, being chlorine-containing, they are environmentally undesirable, contributing to acid rain when incinerated. It would be desirable to omit the PVdC coatings from the BOPP substrate, and replace it with a non-chlorine containing polymer, which would solve the environmental problem. However, although the resulting BOPP film can be adhered to the paper substrate using a conventional adhesive such as PVA, it does not adhere satisfactorily to the paper substrate when using UV-curable adhesives. Processes using PVA rather than UV-curable adhesives are less desirable since adherence of the BOPP film to the paper substrate tends to take longer to complete.

Fatty acid amides are commonly used as slip additives and anti-block additives, and are found in the type of BOPP films mentioned above.

We have now found a solution to the problem of providing an improved thermoplastic film which (i) can be satisfactorily bonded to a paper substrate using a UV-curable adhesive; and (ii) avoids the environmental problems associated with PVdC-coated BOPP films. The thermoplastic film of the invention is also capable of heat sealing at low temperatures.

Accordingly, the present invention provides a process for the manufacture of a polypropylene-paper laminate, comprising providing a film of biaxially-orientated polypropylene which does not carry any PVdC coating, and laminating said film to a paper substrate using a UV-curable adhesive; characterised in that said film is substantially free from fatty acid amides.

The invention further provides a polypropylene-paper laminate comprising a film of biaxially-orientated polypropylene substantially free from fatty acid amides and which does not carry any PVdC coating, bonded to a paper substrate using a UV-curable adhesive.

The invention further provides a film of biaxially-orientated polypropylene substantially free from fatty acid amides, which carries an anti-mist coating on one of its faces.

The invention further provides a package for food, said package comprising a polypropylene-paper laminate, the laminate comprising a film of biaxially-orientated polypropylene which is substantially free from fatty acid amides and which does not carry any PVdC coating, bonded to a paper substrate using a UV-curable adhesive.

As mentioned above, most known packaging intended for use with food having a high moisture content uses BOPP films containing slip additives, anti-block additives and when needed anti-mist additives. Polypropylene films tend to adhere to surfaces due to their high coefficient of friction. Slip additives are widely used to lower the friction between the film and other surfaces. As well as adhering to other surfaces, BOPP films have a tendency to adhere to themselves, making it difficult to separate layers. This adhesion between film layers is called “blocking”, and anti-block additives are commonly added to BOPP. Anti-block additives fall into two broad classes, inorganic (mineral) additives, such as limestone, silica, talc, or zeolites, and organic additives. The latter class includes dispersed waxes (e.g. microcrystalline wax, carnauba wax), natural waxes (e.g. beeswax, paraffin wax, japan wax, montan wax), and synthetic waxes (hydrogenated castor oil, chlorinated hydrocarbon waxes, as well as fatty acid amides).

The most commonly used slip additives are fatty acid amides. Typically, the fatty acid in slip/anti-blocking additives is one derived from a naturally occurring feedstock such as tallow, rapeseed, coconut oil and palm oil. Thus behenamide, erucamide, oleamide, hydrogenated oleamide, stearamide, oleylpalmityl amide, stearyl erucamide and stearyl stearamide are all commonly used, either separately or as mixtures depending on the exact properties required, erucamide and oleamide being the two most common slip additives. The present invention uses a BOPP film which is free from fatty acid amides, specifically, which is free from any one of the fatty acid amides mentioned above.

To enable the film to bond to the paper substrate using a UV-curable adhesive, the BOPP must be substantially free from fatty acid amides. Preferably, the BOPP is substantially free from all slip additives. Preferably, no slip additives are added during the manufacturing process, although it is understood that manufacturing constraints may mean that contaminant slip additives may occasionally be present in the BOPP. Ideally such contaminants, for example fatty acid amides, are present at a level of less than 0.5% wt, more preferably less than 0.1% wt, especially less than 0.01% wt. Further, the BOPP is preferably substantially free from wax; most preferably, the BOPP is free from all organic anti-block additives. Preferably, no organic anti-block additives are added during the manufacturing process, although it is understood that manufacturing constraints may mean that contaminant anti-block additives may occasionally be present in the BOPP. Ideally such contaminants, for example fatty acid amides, are present at a level of less than 0.5% wt, more preferably less than 0.1% wt, especially less than 0.01% wt.

Films comprising BOPP substantially free from slip additives and organic anti-block additives, specifically free from fatty acid amides, are known. Such films are normally used in applications such as vacuum metalizing. They have not previously been used in the manufacture of laminates with a paper substrate for food packaging, in particular they have not been used as a substrate for food packaging that is anti-mist and which is capable of heat sealing at low temperatures.

The BOPP films used in the present invention do not carry any PVdC coating, and preferably do not carry any chlorine-containing polymer coating. Omitting the PVdC layer from BOPP films reduces the heat-sealability of the film, and therefore the BOPP film used in the present invention preferably carries a layer on at least one of its faces which permits heat sealing, especially low-temperature heat sealing. Such layers may be formed of, for example, chlorine-free polymers such as polyethylene, polypropylene, polybutene and/or polyterpene, which may be blended in various ratios to create the desired heat seal performance. Once such films have been bonded to a paper substrate, the resulting laminates have the additional advantage that they can be heat sealed at a temperature lower than the known PVdC-coated BOPP laminates. When film is laminated to a paper substrate, the heat seal temperature will vary depending on the thickness of the substrate. Temperatures of 185° C.-230° C. are typical in a production environment. However, lower heat sealing temperature of a film to itself is understood to be an indicator of lower temperature being required for heat sealing of such a film when bonded to a paper substrate. For example, a PVdC-coated BOPP film such as RK+ can be heat sealed to itself at a temperature of above 95° C. In comparison, the unlaminated film used in the present invention can be heat sealed to itself at about 85° C., or even lower. This lower temperature for heat sealing of the film to itself not only results in the possibility of lower energy costs, it means that lower temperatures on the packing filling lines may be achievable.

Preferably the body of the BOPP film does not contain any anti-mist additives (i.e. within the BOPP film), and preferably the film carries an anti-mist coating on its face remote from the face to be bonded to the paper substrate. Anti-mist coating compositions are available commercially, for example AM 40 available from Sun Chemical contains sodium bis(tridecyl) sulfosuccinate. Further examples of anti-mist additives include primary alcohol ethoxylates, secondary alcohol ethoxylates and nonylphenol alcohol ethoxylates. The anti-mist coating which is present in a preferred embodiment of the invention may be applied to the BOPP film before the lamination process (on top of the heat-sealable polymer layer, if present), or it may be applied as part of the lamination process using an in-line coater. Preferably, because anti-mist coatings tend to be applied using an organic solvent, it is applied to the BOPP film before the lamination process. However, it has been found that if an anti-mist coating is applied across the whole surface of the film at the coat-weights usually recommended by the suppliers of coating compositions, this can adversely affect the heat-seal properties of the film. For example, higher temperatures or longer dwell times may be required in order to burn the anti-mist coating away from the portion of the surface to be heat sealed. Therefore, ideally, the anti-mist coating is applied at a very low concentration. Thus, in a preferred embodiment, the present invention makes use of an anti-mist coating applied at a dry coat-weight of not more than 0.1 gm⁻², preferably less than 0.07 gm⁻², more preferably less than 0.05 gm⁻², still more preferably less than 0.03 gm⁻², yet more preferably less than 0.02 gm⁻², especially less than 0.01 gm⁻².

Preferably, one face of the BOPP film (the face to be bonded to the paper substrate) is subjected to a cleaning step (e.g. subjected to a treatment to increase the surface energy of the film) prior to bonding, in order to enhance the bonding. This step may be part of the manufacturing process for the film, and suitable cleaning methods, including corona discharge treatment and plasma treatment, are well known in the art.

Thus, in an especially preferred embodiment of the invention, the BOPP film carries a coating of a heat-sealable chlorine-free polymer on one of its faces; an anti-mist coating is provided on top of said coating; and the other face of the film has been subjected to a cleaning method. In an alternative embodiment, the BOPP film carries a coating of a heat-sealable chlorine-free polymer on both of its faces; an anti-mist coating is provided on the surface of one of said coatings; while the other surface has been subjected to a cleaning method (e.g. the other surface has been subjected to a treatment to increase the surface energy of the film).

Throughout this Specification and claims, “paper” should be understood to include any grade of paper, including lightweight paper, paperboard, and card. Preferably paperboard is used.

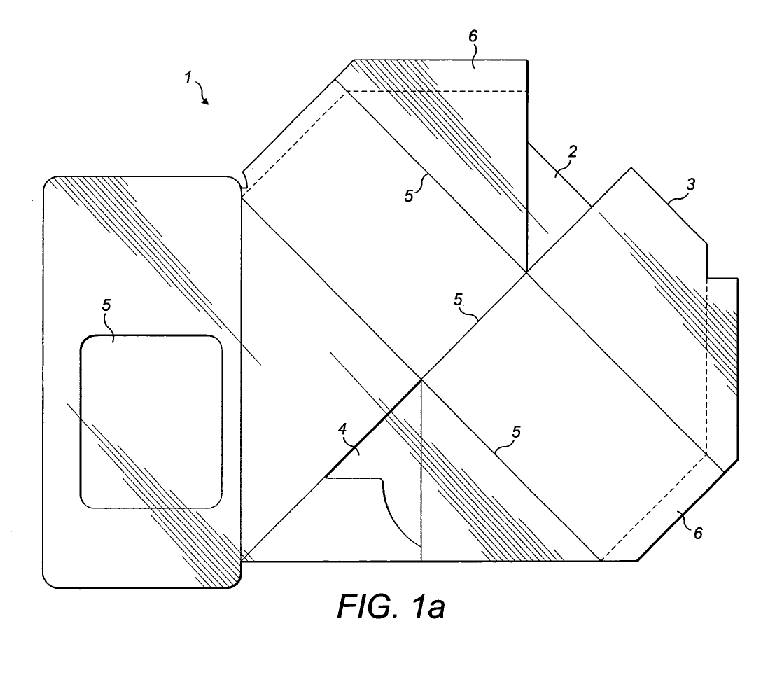

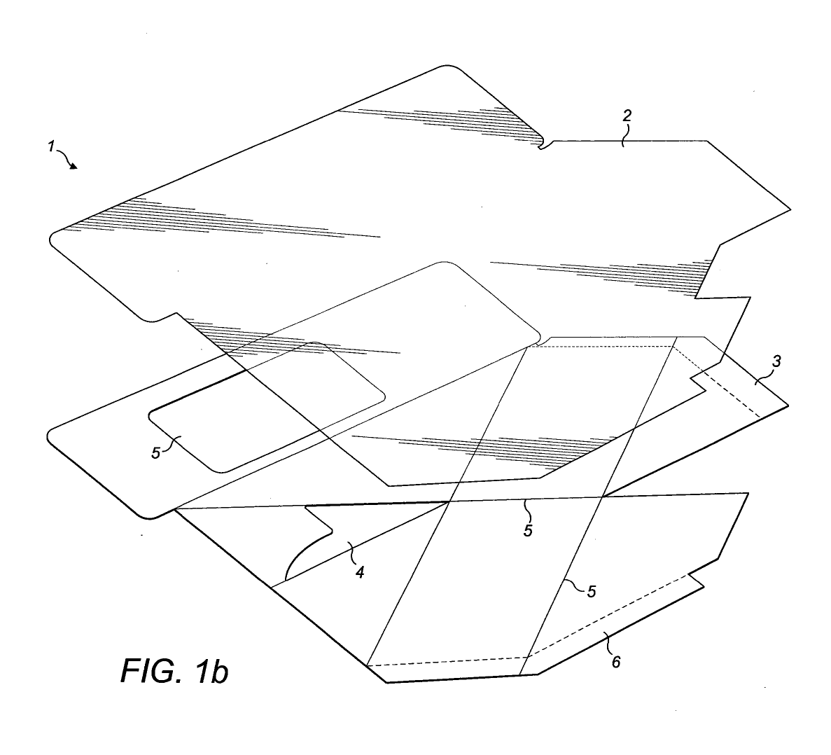

In the attached drawings, FIG. 1a illustrates a blank for a sandwich box made from a laminate according to the invention, and FIG. 1b illustrates an exploded view of the blank of FIG. 1a. The blank, illustrated generally at (1), has on one face a BOPP film (2) which is substantially free from fatty acid amides. The other face of blank (1) is formed by a paperboard substrate (3) having cut-out areas (4) and (5) where no paper is present. Cut-out area (5) provides a transparent window of BOPP in the finished sandwich box. Film (2) is bonded by a UV-curable adhesive to substrate (3). The paperboard face of blank (1) is scored with lines (5) to enable folding into the three-dimensional shape of the finished sandwich box. Tab portions (6) are provided to secure the finished sandwich box into its three-dimensional shape, each tab (6) being capable of being heat-sealed to a complementary portion of blank (1).

The following Examples illustrate the invention.

### EXAMPLE 1

A film comprising Treofan MLD 20 micron coated with Sun Chemical AM40 anti-mist coating with a finished coat weight of 0.05/0.10 grammes per square metre has a surface energy min 38 Dyne on laminating face. This film is laminated to paperboard using a UV-curable adhesive to form.

### EXAMPLE 2

Toray F72W 18 micron coated with Sun Chemical Am40 anti-mist coating with a finished coat weight of 0.05/0.10 grammes per square metre has a surface energy min 40/42 Dyne on laminating face. Lamination of this film to paperboard using a UV-curable adhesive produces a highly satisfactory package for food packaging.

What is claimed:

1. A process for the manufacture of a polypropylene-paper laminate, comprising providing a film of biaxially-orientated polypropylene which does not carry any PVdC coating, and laminating said film to a paper substrate using a UV-curable adhesive; wherein the film does not contain fatty acid amides.

2. The process of claim 1, wherein the film does not contain slip additives.

3. The process of claim 1, wherein the film does not contain waxes.

4. The process of claim 1, wherein the film does not contain organic anti-block additives.

5. The process of claim 1, wherein the film does not carry any chlorine-containing polymer coating.

6. The process of claim 5, in which said film carries on at least one of its faces a layer of chlorine-free polymer which permits heat-sealing.

7. The process of claim 1, wherein the body of the film does not contain any anti-mist additives.

8. The process of claim 1, wherein the film carries an anti-mist coating on its face remote from the face to be bonded to the paper substrate.

9. The process of claim 8, wherein the anti-mist coating is present at a dry coat-weight of less than 0.03 gm⁻².

10. The process of claim 1, wherein the face of the film to be bonded to the paper substrate is subjected to a cleaning step prior to bonding to the paper substrate.

11. The process of claim 1, wherein the film carries a coating of a heat-sealable chlorine-free polymer on one of its faces; an anti-mist coating is provided on top of the coating; and the other face of the film has been subjected to a cleaning method prior to bonding to the paper substrate.

12. The process of claim 1, wherein the paper substrate is made of paperboard.

13. A polypropylene-paper laminate comprising a film of biaxially-orientated polypropylene that does not contain fatty acid amides and which does not carry any PVdC coating, bonded to a paper substrate using a UV-curable adhesive.

14. The laminate of claim 13, suitable for preparation by the process of claim 1.

15. A package for food, comprising the laminate of claim 13.

16. A film of biaxially-orientated polypropylene that does not contain fatty acid amides, and which carries an anti-mist coating on one of its faces.

17. The film of claim 16, suitable for bonding to a paper substrate, wherein:
a) the film does not contain slip additives;
b) the film does not contain waxes;
c) the film does not contain organic anti-block additives;
d) the film does not carry any chlorine-containing polymer coating;
and wherein:
a) the film carries on at least one of its faces that is not bonded to the paper substrate a layer of chlorine-free polymer which permits heat sealing
b) the anti-mist coating is on top of the heat-sealable chlorine-free polymer coating;
c) the anti-mist coating is present at a d ht of less than 0.03 gm²; and
d) the face of the film to be bonded to the paper substrate is subjected to a cleaning step prior to the bonding to the paper substrate.
